(19) United States
(12) Patent Application Publication
(10) Pub. No.: US 2004/0234446 A1
(43) Pub. Date: Nov. 25, 2004

(54) Process for the production of metal fluoride materials

(75) Inventors: F. Conrad Greer, Coppell, TX (US); Ronald L. Elsenbaumer, Arlington, TX (US); David P. Owen, Dallas, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Platinum Research Organization Ltd., Dallas, TX

(21) Appl. No.: 10/662,992

(22) Filed: Sep. 15, 2003

Related U.S. Application Data
(60) Provisional application No. 60/421,716, filed on Oct. 28, 2002.

(51) Int. Cl. C01B 9/08

(52) U.S. Cl. 423/489

(57) ABSTRACT

A process for the production of metal fluorides comprising introducing a predetermined weight of anhydrous hydrofluoric acid into a reaction vessel and initiate a mixing action, preheating a predetermined weight of anhydrous metal to a predetermined reaction temperature, introducing aliquots of the anhydrous metal into the reaction vessel at intervals until the entire predetermined weight of the anhydrous metal has been added, removing excess anhydrous hydrofluoric acid from the reaction vessel, and remove a metal fluoride resultant product from the reaction vessel.

### CROSS-REFERENCE TO RELATED APPLICATIONS

This non-provisional application claims priority to U.S. Provisional Patent Application No. 60/421,716, filed Oct. 28, 2002, entitled METHOD FOR PRODUCING HIGH CATALYTIC ACTIVITY, SUBMICRON, METAL FLUORIDE CATALYST MATERIALS, the disclosure of which is hereby incorporated by reference in its entirety.

### TECHNICAL FIELD

The present application relates to the manufacture of metal fluorides to be employed as catalysts or for any other use.

### BACKGROUND

Metal fluorides are employed in a large number of industrial applications, including but not necessarily limited to the following applications:

Production of porcelain and ceramic materials for a large number of applications;

Production of materials useful in dyeing operations, such as mordants;

Production of specialty glass formulations, particularly useful for optical transmission conductors;

Production of antiseptics and germicides;

Production of etching agents, particularly useful in the preparation of printed circuits;

Production of thermal decomposition coatings as well as other coating applications such as thin film optical coatings;

Production of fluoridating agents; and

Production of catalyst materials for a wide range of applications.

It is known by those skilled in the art that in many instances metal fluorides may be produced by combining a metal or a nonfluorinated metal compound, for example, nonfluorinated metal salts, hereinafter simply referred to as metal compounds, with hydrofluoric acid. For example, when the reactant is a metal, the reactions are basically as follows:

2M+2HF→2MF+H₂↑

M+2HF→MF₂+H₂↑

2M+6HF→2MF₃+3H₂↑

M+4HF→MF₄+2H₂↑

When the metal compound is a metal chloride (salt), the reactions are basically as follows:

MCl+HF→MF+HCl↑

MCl₂+2HF→MF₂+2HCl↑

MCl₃+3HF→MF₃+3HCl↑

MCl₄+4HF→MF₄+4HCl↑

The reaction between metal chlorides and hydrofluoric acid may be endothermic. In such cases, in order for the reactions to go to completion, the reactants must absorb heat from their environment. Where the reactions are endothermic, it has been observed that the higher the temperature at the time of the reaction, the greater the rate of heat delivery to the reactants and the smaller are the resultant metal fluoride particles. In general, the smaller the metal fluoride particles, the greater the exposed surface area per unit of weight of the resultant metal fluoride. In view of the fact that catalysts are surface active agents, the greater surface area per unit of weight commonly associated with the smaller particles, would be expected to exhibit greater catalytic activity, and such has been shown to be the case.

In the event that the reaction between the metal chloride and the anhydrous hydrofluoric acid is exothermic, the reaction would need to give up heat to its environment in order to go to completion. In which case, the conclusion cited above for an endothermic reaction would be expected to be the opposite for the exothermic reaction case. That is to state, that it would be expected that the lower the reaction temperature, the more readily the heat generated by the exothermic reaction would be absorbed by the reaction environment and the resultant metal fluoride product would be expected to exhibit relatively smaller particle sizes.

The process of combining metal, and/or metal compounds, and hydrofluoric acid may have somewhat varied results depending on which metal, or metal compound, is employed; however, in order to illustrate the general reaction, the specific case of the production of ferric trifluoride by combining ferric trichloride and anhydrous hydrofluoric acid is cited herein.

The process of combining ferric trichloride and anhydrous hydrofluoric acid causes the following events to occur:

The ferric trichloride is dissolved and ionized by the liquid anhydrous hydrofluoric acid;

The individual molecule of dissolved and ionized ferric trichloride exchanges the first chloride atom with a fluoride atom from the liquid, ionized, anhydrous hydrofluoric acid source and in so doing, the individual molecular reaction product remains soluble and ionized as FeFCl₂, ferric fluoride dichloride, along with the evolution of hydrochloric acid gas (wherein the system pressure is at one atmosphere and the system temperature is at temperatures above −84.9° C.); and

The individual dissolved and ionized ferric fluoride dichloride exchanges the second and third chloride atoms with two fluoride atoms from the liquid, ionized, anhydrous hydrofluoric acid source and, in so doing, the ferric trichloride molecule goes through a transition wherein the ferric trichloride and subsequently the ferric fluoride dichloride are soluble in the anhydrous hydrofluoric acid to where the molecule becomes essentially totally insoluble as ferric trifluoride in the liquid anhydrous hydrofluoric acid and precipitates as a lime green solid, while simultaneously liberating additional hydrochloric acid gas.

It is the currently accepted practice to add liquid anhydrous hydrofluoric acid to solid ferric trichloride when manufacturing ferric trifluoride, as is set forth in detail in U.S. Pat. No. 4,938,945, the disclosure of which is hereby incorporated by reference herein. One of the reasons for this is safety. It is generally accepted that there is a lower propensity for the reactants to splatter and, hence, this method is deemed to be a safer process than adding the ferric trichloride to the anhydrous hydrofluoric acid. However, it is manifestly obvious that in this process, the first weight aliquot of ferric trichloride is exposed to a very limited quantity of anhydrous hydrofluoric acid (very low weight ratio of anhydrous hydrofluoric acid to ferric trichloride). Each subsequent aliquot of ferric trichloride is also exposed to a limited weight ratio of anhydrous hydrofluoric acid to ferric trichloride. Sufficient anhydrous hydrofluoric acid is added until the predetermined weight ratio is eventually established. However, at that point all of the ferric trichloride has reacted at a weight ratio of anhydrous hydrofluoric acid to ferric trichloride that is significantly below the predetermined level. It is contended that this aspect of the process results in reaction products that exhibit relatively large primary particles, agglomeration of the primary particles, slow reaction times, incomplete reactions, low to no resultant catalytic activity, and poor quality control with respect to the chemical and physical characteristics of the resultant ferric trifluoride product.

Furthermore, it is the currently accepted practice to combine the ingredients in the ferric trifluoride manufacturing process at atmospheric pressure. In light of the fact that liquid anhydrous hydrofluoric acid boils at 19.8° C. (67.6° F.) at standard atmospheric pressure, the boiling point of the anhydrous hydrofluoric acid limits the temperature to which the environment of the reactants may be elevated prior to and during the reaction. In the absence of temperature controlling apparatus and/or equipment, the manufacturing process will tend to experience cooling while the ingredients are being combined because of the endothermic nature of the reaction. Thereafter, the resultant product temperature will tend to modulate at some temperature between the ambient temperature and 19.8° C. (67.6° F.), the boiling point of anhydrous hydrofluoric acid at standard atmospheric pressure, if the ambient temperature is lower than 19.8° C. However, if the ambient temperature is greater than 19.8° C. (67.6° F.), the resultant product temperature will tend to remain at 19.8° C. (67.6° F.) until all of the anhydrous hydrofluoric acid has evaporated. Thereafter, the temperature will modulate upward to the ambient temperature.

Following the completion of the reaction, it is currently accepted practice to allow the resultant ferric trifluoride product to remain submerged in the liquid anhydrous hydrofluoric acid for three to ten days. The longer residence time (“pickling time”) generally results in a more complete reaction which in turn yields a more pure ferric trifluoride product.

Following the reaction period and the residence period, it is currently accepted practice to separate the resultant solid ferric trifluoride product from the remaining anhydrous hydrofluoric acid by decanting and/or evaporating the acid. Thereafter, the ferric trifluoride product is dried in stages until the ultimate temperature is approximately 240° C. In so doing, it is anticipated that any free residual anhydrous hydrofluoric acid and/or any free water shall be driven off, leaving an anhydrous ferric trifluoride product. The product is then packaged in such a manner as to isolate it from the environment and avoid the absorption of moisture and other contaminates.

### SUMMARY OF THE INVENTION

Each of the applications listed above has significant commercial importance. However, the inventors of the present invention have an extraordinary interest in the production of catalyst materials. The invention set forth herein is intended to be broad enough to cover the various permutations of the processes for the production of metal fluorides for any purpose or application, without limitation to the production of catalyst materials and the maintenance of the necessary specifications required of the subject catalyst materials as is set forth in the exemplary embodiments herein.

The present invention differs from the prior art processes by adding the solid metal reactant to the liquid anhydrous hydrofluoric acid reactant. As noted above, in the prior art, for reasons such as safety, the practice has been to add the liquid hydrofluoric acid to the metal solid.

The present invention also employs one or more of the following to improve the production of catalyst materials, such as, for example, ferric trifluoride:

The higher the temperature of the reactants, up to a maximum of 19.8° C. (67.6° F.), the smaller the resultant ferric trifluoride product particles.

Stirring or agitation during the addition of the anhydrous hydrofluoric acid to the ferric trichloride appears to result in smaller ferric trifluoride particles, and it clearly reduces the necessary residence time of the ferric trichloride within the anhydrous hydrofluoric acid to cause a complete reaction, which produces more nearly pure ferric trifluoride.

The greater the weight ratio of anhydrous hydrofluoric acid to ferric trichloride, up to a weight ratio of 60 to 1, the smaller the resultant ferric trifluoride product particle diameters.

The longer the reaction product is allowed to reside in the anhydrous hydrofluoric acid environment the more complete is the reaction and, hence, the more nearly pure is the resultant ferric trifluoride product.

The resultant ferric trifluoride product that exhibits discrete, unagglomerated primary particles in the submicron particle diameter range has proven also to exhibit a greater catalytic effect in certain specific reactions, wherein PTFE is caused to react with steel and aluminum at ambient temperature and at atmospheric pressure. See, for example, U.S. Pat. No. 5,877,128, the disclosure of which is hereby incorporated by reference herein. Hence, the smaller submicron ferric trifluoride particles are deemed generally to constitute a better catalytic product.

The specific metal fluorides to be utilized as catalyst materials preferably should exhibit the following properties and specifications, when finished, in order to serve the intended purpose:

The catalyst materials preferably should have individual particle diameters no larger than 0.50 microns.

The catalyst materials preferably should not be agglomerated. Each particle preferably should be discrete and preferably should be unattached to every other particle.

The catalyst chemistry preferably should be at least 99.9% pure and devoid of stray elements and contaminants, including water.

The catalyst material preferably should not exhibit a pH of less than 3.5 when slurried in demineralized water at a weight ratio of 1 gram of material to 10 grams of demineralized water.

The catalyst materials must be active as a catalyst.

Metal fluorides produced for other purposes may have the same specifications or they may have a wholly different slate of specifications. Whereas it is not the intention to limit the process of this invention to the production of catalyst materials only, special emphasis shall be dedicated to the process for the production of catalyst materials having the specifications cited herein. In fact, the preferred embodiment presented hereinafter is specifically devoted to the process for the production of ferric trifluoride catalyst material.

It is an object of the present invention to maintain higher reaction temperatures. Elevating the temperature at which the reaction between ferric trichloride and anhydrous hydrofluoric acid takes place results in smaller diameter particles of the resultant ferric trifluoride product.

It is an additional object of the invention to effect stirring and/or agitation during the reaction. Stirring or agitation has been concluded to be beneficial to the subject process.

It is a further object of the invention to maintain high weight ratio of anhydrous hydrofluoric acid to ferric trichloride during the reaction. Maintaining a high weight ratio (e.g. up to 60 to 1) of anhydrous hydrofluoric acid to ferric trichloride during the reaction results in smaller diameter particles of the resultant ferric trifluoride product, results in a faster and more complete reaction, and results in a more nearly pure reaction product.

It is a further object of the invention to minimize the residence time needed to complete the reaction. Long residence time should not be required. As was stated earlier, the reaction between the ferric trichloride and the anhydrous hydrofluoric acid takes place in an instant. The manner in which the reaction process is conducted using currently accepted practices results in the need for long residence time in order for the reaction to go to completion. It is concluded that elevating the reaction temperature, maintaining the optimum anhydrous hydrofluoric acid to ferric trichloride weight ratio, and adequate agitation and/or stirring will result in a complete reaction with the production of submicron, nonagglomerated particles of ferric trifluoride that are catalytically active, without exposing the reactants to long residence times.

It is another object of the invention to maximize catalytic activity. Based on the aforementioned observations, it is contended that if the processes disclosed herein are invoked and followed, the resultant ferric trifluoride product will not only be composed of discrete, nonagglomerated submicron particles, but it should also exhibit greater surface area per unit of weight and exhibit much greater catalytic activity with respect to the test conditions recited herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

FIG. 1 is a graph illustrating the relationship between vapor pressure and temperature for anhydrous hydrofluoric acid.

### DETAILED DESCRIPTION

The present invention is predicated on the observation that the metal fluoride reactant product derived from this novel process for the production of metal fluorides, wherein metal and/or nonfluorinated metal compounds (e.g. metal salts) are added to anhydrous hydrofluoric acid, can be caused to exhibit desired specifications by altering the anhydrous hydrofluoric acid to metal and/or metal compound weight ratio at the time of the reaction, by controlling the reaction temperature, pressure, stirring and/or agitation, residence time and the method of packaging and protecting the resultant metal fluoride product.

The process of the invention involves the following steps:

Provide a clean, appropriately designed and constructed reaction vessel capable of withstanding exposure to anhydrous hydrofluoric acid and internal system working pressures and temperatures in the range of zero to 400 psia and −200° F. to 300° F., respectively. The reaction vessel should be equipped with appropriately designed and constructed valves that will permit the introduction and withdrawal of the reactants and the resultant products, respectively. The reaction vessel should also be equipped with an appropriately designed and constructed automatic regulating gas back pressure valve, settable at back pressures ranging from zero psia to 400 psia. The reaction vessel should also be equipped with appropriately designed and constructed cooling and heating equipment, complete with a thermostatic controller, and rotating, stirring and/or agitation equipment, complete with variable automatic controls. In addition, the reaction vessel should be equipped with an appropriately designed and constructed plunger type device that conveniently shall allow the introduction of solid, granular reactant materials while the reaction vessel is under vacuum or pressure, without allowing the fluids within the vessel to escape.

Provide an essentially chemically pure (e.g. catalyst grade) anhydrous metal and/or a nonfluorinated metal compound (“metal compound”) to serve as one of the reactants.

Provide a supply of anhydrous hydrofluoric acid to serve as one of the reactants.

Prepare the reaction vessel by cleaning the interior surfaces and all of the portals, valves, and other surfaces leading to or from the reaction vessel.

Purge the reaction vessel a minimum of three successive times with pure nitrogen gas. Fill the reaction vessel a fourth time with pure nitrogen gas, to the pressure at which it is intended to conduct the reaction.

Introduce the predetermined weight of anhydrous hydrofluoric acid into the reaction vessel through the valve and port designed for such purpose.

Engage the thermostatically controlled reaction vessel cooling or heating equipment. Set the thermostat at the desired reaction temperature and bring the reaction vessel and its contents up to the desired reaction temperature. In one embodiment, a reaction temperature of 45° C. is used as the reaction temperature.

Initiate rotation, stirring and/or agitation action and set the controller.

Preheat the predetermined weight of anhydrous metal and/or metal compound to the predetermined reaction temperature.

Introduce the predetermined weight of metal and/or metal compound into the reaction vessel through the plunger device and port designed for such purpose. Introduce only small aliquots (e.g. ±10%) of the entire predetermined weight of metal and/or metal compound with each stroke of the plunger. Allow a few minutes for the reaction to take place, then introduce successive aliquots in a like manner until the entire predetermined weight of anhydrous metal and/or metal compound has been introduced. It is important to state again that the weight ratio of the anhydrous hydrofluoric acid to anhydrous metal and/or metal compound should be some multiple of the stoichiometric combining weight of the metal and/or metal compound reactant, preferably not less than 2 and not greater than 60. The optimum ratio may be established by producing batches of the metal fluoride at various ratios and then rating the resultant metal fluoride by the resultant specifications of the produced metal fluoride product and the suitability of such specifications for the intended application of such product.

Exhaust the internally generated gaseous resultant product as needed to maintain the optimum reaction pressure and/or temperature through the automatic regulating gas back pressure valve at all times during the process, and do so, as required, in a safe and environmentally acceptable manner.

After the reactants have been fully introduced into the reaction vessel, allow the reaction vessel to remain at the predetermined reaction pressure and temperature with the rotating, stirring and/or agitation equipment in service for approximately four hours or such other minimum period of time that may prove to be effective and/or beneficial for the production of the resultant metal fluoride product and the specifications required thereof.

Thereafter, remove the excess anhydrous hydrofluoric acid by evaporating it from the reaction vessel through the automatic regulating gas backpressure valve. This may be accomplished by progressively reducing the set pressure on the automatic regulating gas backpressure valve while maintaining the elevated temperature above 19.8° C. (67.6° F.) on the reaction vessel, until all of the anhydrous hydrofluoric acid has volatilized. The vapor phase anhydrous hydrofluoric acid may be passed through a heat exchanger to reduce the temperature below the condensation temperature (19.8° C. or 67.6° F.) at standard atmospheric pressure. The anhydrous hydrofluoric acid recovered in this manner may be condensed and utilized again. Other resultant gaseous product generated during or after the reaction may be separated from the anhydrous hydrofluoric acid by distillation and condensation, using a separation process that recognizes the difference in boiling and/or condensation points at the operating pressure of this secondary process.

Remove the solid, submicron metal fluoride resultant product through the valves and ports provided on the base of the reaction vessel.

Place the resultant solid, submicron metal fluoride product in an appropriately designed and constructed open container and place the container and its contents in an appropriately designed and constructed oven capable of maintaining an inert environment while heating the metal fluoride. Heat the container and its contents at 95° C.±4° C. for a period of approximately two hours. Thereafter, bring the temperature of the metal fluoride and its container up to within 10° C. of the metal fluoride's decomposition or melting point, whichever temperature is the lower. Maintain the peak temperature for a period of approximately one hour, then cool the metal fluoride to ambient temperature in a sealed desicator, free of all moisture and stray gases.

Package the metal fluoride in a sealed container that will protect the material from coming into contact with moisture, stray gases, or any other substances that might cause the metal fluoride to become contaminated.

The process of this invention is illustrated hereinafter by citing a preferred embodiment of the process in the production of ferric trifluoride.

A clean 150 liter (40 gallon) reaction pressure vessel, constructed of Nickel metal and designed with a working pressure rating of zero to 400 psia and working temperature rating of zero to 300° F. is equipped with thermostatically controlled resistance heating equipment capable of being set at any temperature within the working temperature range and ultrasound agitation equipment complete with a settable controller. Furthermore, the reaction vessel is equipped with at least five working pressure and temperature rated gate valves designed to provide convenient introduction of the reactants and the withdrawal of the resultant reaction products, three on the top of the vessel and two on the bottom of the cone shaped base of the vessel, which terminates in a pressure lock chamber consisting of a pipe nipple, separated by the two bottom gate valves. In addition, the reaction vessel is equipped with an appropriately designed and constructed automatic regulating gas back pressure valve that permits the setting and maintenance of any constant pressure, between zero psia and 400 psia, within the vessel. The reaction vessel is also equipped with a plunger device which enables solid anhydrous ferric trifluoride reactant to be introduced into the reaction vessel at all pressures up to the full working pressure of the vessel.

The vessel is first cleaned of all stray chemicals and materials, which might otherwise contaminate the resultant product.

The clean reaction vessel is next purged three successive times with pure nitrogen gas. Thereafter, the reaction vessel is pressured to 125 psia with nitrogen gas. The back pressure regulator on the reaction vessel is set at 125 psia.

The reaction vessel is then loaded with 80 kg (100 liters) of anhydrous hydrofluoric acid, which is pumped into the vessel under pressure. Note, nitrogen gas will escape as the anhydrous hydrofluoric acid is being displaced into the vessel, in view of the fact that the back pressure regulator will maintain a constant back pressure of 125 psia.

The reaction vessel resistance heater and ultrasound agitation devices are then engaged and the reaction vessel temperature is brought up to a thermostatically controlled temperature of 200° F.

Theoretically, at the basic stoichiometric combining ratios, as much as 150.4 kg of anhydrous ferric trichloride could be added to the 80 kg of anhydrous hydrofluoric acid in the reaction vessel and the reaction could be expected to go to completion. However, previous observations have taught that high weight ratios of anhydrous hydrofluoric acid to ferric trichloride have quite reliably resulted in submicron size particles of a more pure resultant ferric trifluoride product.

In this preferred embodiment of this invention, a weight ratio of anhydrous hydrofluoric acid to ferric trichloride of 60 to 1 is employed. Therefore, 1.33 kg of 99.9% pure (catalyst grade) anhydrous ferric trichloride is preheated to 200° F. and then it is introduced into the reaction vessel under pressure, using the plunger device. In view of the fact that it is an object of this invention that the ferric trichloride is to be introduced slowly and uniformly, not more than 133 grams are introduced with each cycle of the plunger device. Furthermore, five minutes of reaction time is allowed between each successive aliquot addition.

The ferric trifluoride formed upon the reaction of the anhydrous ferric trichloride and the anhydrous hydrofluoric acid is immediately insoluble, and is denser than the anhydrous hydrofluoric acid. As a consequence, the ferric trifluoride gravitates to the base of the vessel and settles into the pressure lock chamber on bottom, formed with the two lower gate valves and the pipe nipple in between. The solid resultant product collection process, as well as the reaction itself, is aided to a great extent by the ultrasound agitation on the vessel.

During the reaction hydrochloric gas is evolved and insofar as the gas pressure in the reaction vessel exceeds the back pressure valve setting of 125 psia, the excess hydrogen chloride gas is automatically allowed to escape from the reaction vessel, perhaps along with some of the nitrogen gas used initially to charge and blanket the reaction vessel. The anhydrous hydrofluoric acid, on the other hand, should remain in the liquid phase at the reaction pressure and temperature conditions of 125 psia and 200° F.

Following the reaction, the solid reactant product is allowed to remain in contact with the anhydrous hydrofluoric acid for a period of approximately four hours, while the reaction vessel is maintained at 125 psia and 200° F. and is continued to be agitated by the ultrasound device.

The excess hydrofluoric acid is then removed by evaporating it from the reaction vessel through the automatic regulating gas back pressure valve. This is accomplished by progressively reducing the set pressure on the automatic regulating gas back pressure valve while maintaining the elevated temperature above 19.8° C. (67.6° F.) on the reaction vessel, until all of the anhydrous hydrofluoric acid has been volatilized. The vapor phase anhydrous acid is then passed through a heat exchanger to reduce the temperature below the condensation temperature (19.8° C. or 67.6° F.) at standard atmospheric pressure and thereby recover the unused anhydrous hydrofluoric acid in the liquid phase.

Thereafter, the reaction vessel is cooled down to some temperature below 19.8° C. (67.6° F.) and the resultant submicron ferric trifluoride product is removed from the gate valves on the bottom of the reaction vessel provided for such purpose.

Once the resultant ferric trifluoride product is collected, it is dried in an inert atmosphere at temperatures up to 99° C. Thereafter, the ferric trifluoride is heated up to 290° C. to drive off any remaining water and/or anhydrous hydrofluoric acid.

Thereafter, the ferric trifluoride resultant product is allowed to cool to ambient temperature in a desicator vessel. Then the ferric trifluoride product is promptly packaged and seated in such a manner so as to avoid contact with its environment, hence avoiding hydration and/or any other forms of contamination.

Additional batches of ferric trifluoride may be produced by repeating the procedures cited above.

In other embodiments, the objects of the invention may be accomplished in alternative ways as discussed in further detail below.

One object of the invention is to maintain higher reaction temperatures. Elevating the temperature at which the reaction between ferric trichloride and anhydrous hydrofluoric acid takes place results in smaller diameter particles of the resultant ferric trifluoride product. A high temperature reaction may be achieved, for example, using the following processes.

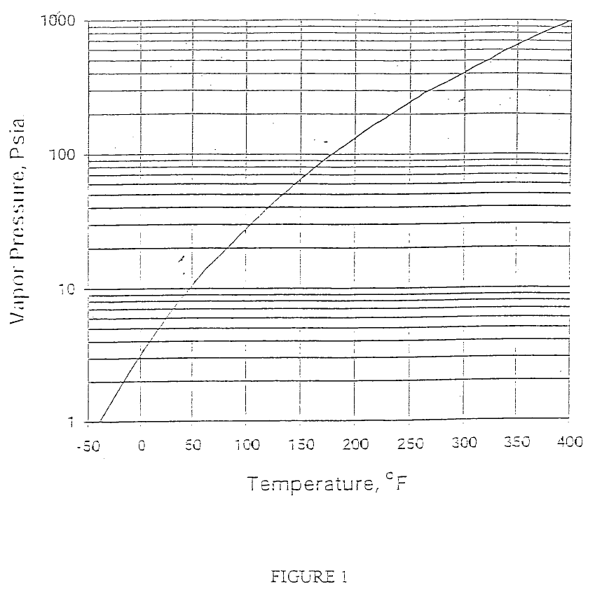

Heating under pressure: By creating a pressure resistant reaction vessel made of nickel, nickel alloy, or other metals completely lined with PTFE or other polymers that can withstand the rigors of exposure to anhydrous hydrofluoric acid at the rated reaction vessel operating temperatures and pressures, the temperature of the anhydrous hydrofluoric acid can be elevated to the boiling point of the acid at the pressure rating of the reaction vessel without loss of the hydrofluoric acid through evaporation. FIG. 1 is a graph illustrating the vapor pressure of anhydrous hydrogen fluoride. The reaction vessel would logically need to be equipped with a pressure relief valve both for safety purposes and to allow the hydrochloric acid gas generated during the reaction to escape.

Preheat: The reactants, anhydrous hydrofluoric acid and ferric trichloride, may be preheated prior to being combined. For example, the anhydrous hydrofluoric acid could be preheated up to the point where the vapor pressure of the acid equaled the working pressure of the reaction vessel. For example, the graph of FIG. 1 may be used to identify a maximum temperature that should be used for the reaction vessel's working pressure. Similarly, the ferric trichloride may be preheated up to approximately 300° C. prior to combining it with the anhydrous hydrofluoric acid. Note: ferric trichloride has a melting point of 306° C. and a boiling point of 319° C.; however, it begins to decompose at or slightly below its melting point of 306° C.

Continuous heating by various means: In the event the reaction vessel is made of PTFE or some other anhydrous hydrofluoric acid resistant polymer and not made of metal, it may be continuously heated using microwave energy insofar as the pressure rating of the reaction vessel is not exceeded through such heating operation. It is important to point out that microwave heating may result in vapor bubbles being formed beneath the surface of the liquid anhydrous hydrofluoric acid and such bubbles could burst to the surface resulting in a serious safety hazard. In the event the reaction vessel is made of metal, it may be continuously heated by more conventional means such as electrical resistance, electrical induction, flame or steam. In addition, some heating and mixing may be achieved by imposing high energy ultrasound on the reaction vessel.

Another object of the invention is to effect stirring and/or agitation during the reaction. Stirring or agitation is beneficial to the process disclosed herein. Stirring and agitation may be accomplished, for example, in the following ways:

Rotation: The reaction vessel may be supported in such a manner as to allow it to be rotated in one or more planes during the period of the reaction.

Ultrasound: Irrespective of the materials of which the reaction vessel is constructed, the ingredients of the reaction vessel may be agitated using a high energy ultrasound source. The ultrasound, to a lesser degree, will serve to add heat to the reaction vessel, as well.

Magnetic stirring device: The reaction vessel could be stirred with a magnetic stirring device.

Conventional stirring device: The reaction vessel could be stirred with a conventional stirring device employing an electric motor and one or more rotating paddles, such as a Lightening Mixer, introduced through an appropriately designed and constructed pressure packing gland.

A further object of the invention is to maintain high weight ratio of anhydrous hydrofluoric acid to ferric trichloride during the reaction. Maintaining a high weight ratio (e.g. up to 60 to 1) of anhydrous hydrofluoric acid to ferric trichloride during the reaction results in smaller diameter particles of the resultant ferric trifluoride product, results in a faster and more complete reaction, and results in a more nearly pure reaction product. A high weight ratio of anhydrous hydrofluoric acid to ferric trichloride may be achieved, for example, as follows:

Add the solid ferric trichloride to the liquid anhydrous hydrofluoric acid: It is known that the reaction between anhydrous hydrofluoric acid and ferric trichloride takes place in discernable steps, but the entire reaction takes place in an instant. The degree to which the reaction goes to completion, forming a relatively pure end product, is dependent upon the weight ratio of the reactants and the amount of residence time. In a batch manufacturing process, the weight ratio of anhydrous hydrofluoric acid to ferric trichloride may be more readily maintained at the optimum value, if the solid ferric trichloride is added to the liquid anhydrous hydrofluoric acid in an enclosed reaction vessel, enclosed for safety, to permit ease of mixing, to retain pressure, to retain volatile reactants and/or reactant products, and to permit heating above the atmospheric boiling point of the anhydrous hydrofluoric acid.

For each weight aliquot of the solid ferric trichloride that is added to the liquid anhydrous hydrofluoric acid the weight ratio of the reactant will be the most favorable possible for the fixed quantities of the two reactants being employed. This is so, because as each weight aliquot of the ferric trichloride is introduced into the reaction vessel containing the anhydrous hydrofluoric acid, the reaction shall take place in an instant and the resultant product, ferric trifluoride, shall precipitate and gravitate to the bottom of the reaction vessel. In this process, only a relatively small fraction of the anhydrous hydrofluoric acid shall be consumed. Therefore, when the next weight aliquot of the ferric trichloride is introduced into the reaction vessel, it will encounter approximately the same weight ratio of anhydrous hydrofluoric acid to ferric trichloride, as did the initial aliquot of ferric trichloride. If the process is commenced with an initial weight ratio of 60 to 1, anhydrous hydrofluoric acid to ferric trichloride, the last of ten aliquots of ferric trichloride shall encounter a weight ratio of no less than 56 to 1.

The chemical reaction that takes place when ferric trichloride is combined with anhydrous hydrofluoric acid is set forth below, wherein the stoichiometric combining weight of each chemical in the reaction is cited below each such chemical, as follows:

| FeCl₃ | + | 3 HF | → | FeF₃ | + | 3HCl ↑ |
|---|---|---|---|---|---|---|
| 162.2031 | | 60.0189 | | 112.8402 | | 109.3818 |

Presupposing one gram mole or 162.2031 grams of ferric trichloride were to be combined with a quantity of anhydrous hydrofluoric acid in a weight ratio of sixty (60) parts anhydrous hydrofluoric acid to one (1) part ferric trichloride, the first aliquot of one gram mole or 162.2031 grams of ferric trichloride would be introduced into 9,732.1860 grams of anhydrous hydrofluoric acid (60 to 1 weight ratio). The reaction would result in the consumption of 60.0189 grams of anhydrous hydrofluoric acid leaving 9,672.1671 grams of anhydrous hydrofluoric acid unreacted.

The second aliquot of one gram mole or 162.2031 grams of ferric trichloride would be introduced into the remaining 9,672.1671 grams of anhydrous hydrofluoric acid to cause a reaction and the consumption of an additional 60.0189 grams of anhydrous hydrofluoric acid, leaving 9,612.1482 grams of anhydrous hydrofluoric acid unreacted. The combining ratio with the addition of the second aliquot would be 59.6300 to 1, anhydrous hydrofluoric acid to ferric trichloride, prior to the reaction and 59.2600 to 1, after the reaction.

Similarly, the combining ratios for the first ten aliquots of one gram mole each or 162.2031 grams of ferric trichloride (“FeCl₃”) introduced into the initial quantity (9,732.1860 grams) of anhydrous hydrofluoric acid (“AHF”) is as follows:

| FeCl₃ | AHF Grams | Weight Ratio of |
|---|---|---|
| Aliquot No. | Remaining | AHF to FeCl₃ |
| 0 | 9,732.1860 | 60.0000 to 1 |
| 1 | 9,672.1671 | 59.6300 to 1 |
| 2 | 9,612.1482 | 59.2600 to 1 |
| 3 | 9,552.1293 | 58.8899 to 1 |
| 4 | 9,492.1104 | 58.5199 to 1 |
| 5 | 9,432.0915 | 58.1499 to 1 |
| 6 | 9,372.0726 | 57.7799 to 1 |
| 7 | 9,312.0537 | 57.4098 to 1 |
| 8 | 9,252.0348 | 57.0398 to 1 |
| 9 | 9,192.0159 | 56.6698 to 1 |
| 10 | 9,131.9970 | 56.2998 to 1 |

Following this hypothetical ten step reaction process, the remaining anhydrous hydrofluoric acid could be salvaged and used again.

This major change from the present state of the art should result in much faster reactions, more complete reactions, more nearly pure resultant product, and significantly better quality control. Therefore, irrespective of the weight ratio of anhydrous hydrofluoric acid to ferric trichloride employed in the reaction, only the stoichiometric combining weights of the reactants should be consumed in the reaction. The surplus hydrofluoric acid may be recovered and used again.

Add Proportionate Quantities of Anhydrous Hydrofluoric Acid During the Process: Once the optimum weight ratio of anhydrous hydrofluoric acid to ferric trichloride has been clearly established, it may be recommendable to add anhydrous hydrofluoric acid to the reaction vessel in order to maintain the optimum weight ratio, prior to the addition of the next aliquot of ferric trichloride, depending of course on how critical the optimum weight ratio proves to be for the specific reaction.

In one embodiment of the invention, a process for the production of metal fluorides comprises the processes listed below.

A clean, appropriately designed and constructed reaction vessel that is capable of withstanding exposure to anhydrous hydrofluoric acid and internal system working pressures and temperatures in the range of zero to 400 psia and −200° F. to 300° F., respectively, is provided. The reaction vessel may be equipped with appropriately designed and constructed valves that permit the introduction and withdrawal of reactants and the resultant products, respectively.

The reaction vessel may also be equipped with an appropriately designed and constructed automatic regulating gas back pressure valve that is settable at back pressures ranging from zero psia to 400 psia. The reaction vessel may be equipped with appropriately designed and constructed cooling and heating equipment and may have a thermostatic controller. In one embodiment, the reaction vessel has rotating, stirring and/or agitation equipment and may also have variable automatic controls.

The reaction vessel may be equipped with an appropriately designed and constructed plunger-type device that allows for the introduction of solid, granular reactant materials while the reaction vessel is under vacuum or pressure, without allowing the fluids to escape from or enter into the reaction vessel.

An essentially chemically pure (e.g. catalyst grade) anhydrous metal and/or nonfluorinated metal compound (“metal compound”) are provided to serve as one of the reactants. A supply of anhydrous hydrofluoric acid is provided to serve as one of the reactants.

The reaction vessel may be cleaned, including the interior surfaces and all of the portals, valves, and other openings leading to or from the reaction vessel. In one embodiment, the reaction vessel is purged a minimum of three successive times with pure nitrogen gas. Then, the reaction vessel is filled a fourth time with pure nitrogen gas to the pressure at which the reaction is intended to occur.

A predetermined weight of anhydrous hydrofluoric acid is introduced into the reaction vessel through the valves and ports designed for such purpose. The thermostatically controlled reaction vessel cooling or heating equipment is engaged, and the reaction vessel and its contents are heated to the desired reaction temperature. Rotation, stirring, agitation action and/or other mixing action is initiated.

The predetermined weight of anhydrous metal and/or metal compound is preheated to the predetermined reaction temperature. The predetermined weight of metal and/or metal compound is introduced into the reaction vessel through the plunger device and port designed for such purpose. In a preferred embodiment, only small aliquots (e.g. ±10%) of the entire predetermined weight of metal and/or metal compound are added with each stroke of the plunger.

After allowing a few minutes for the reaction to take place, successive aliquots are introduced in a like manner until the entire predetermined weight of anhydrous metal and/or metal compound has been introduced. The weight ratio of the anhydrous hydrofluoric acid to anhydrous metal and/or metal compound should be some multiple of the stoichiometric combining weight of the metal and/or metal compound reactant, preferably not less than 2 and not greater than 60. The optimum ratio may be established by producing batches of the metal fluoride at various ratios and then rating the resultant metal fluoride product by the resultant specifications of the produced metal fluoride product and the suitability of such specifications for the intended application of such product.

The internally generated gaseous resultant product is preferably exhausted through the automatic regulating gas back pressure valve at all times during the process and is done in a safe and environmentally acceptable manner.

After the reactants have been fully introduced into the reaction vessel, allow the reaction vessel to remain at the predetermined reaction pressure and temperature with the rotating, stirring, agitation and/or mixing equipment in service for approximately four hours or such other minimum period of time that may prove to be effective and/or beneficial for the production of the resultant metal fluoride product and the specifications required thereof

The excess anhydrous hydrofluoric acid may be removed by evaporating it from the reaction vessel through the automatic regulating gas back pressure valve. This may be accomplished by progressively reducing the set pressure on the automatic regulating gas back pressure valve while maintaining the elevated temperature above 19.8° C. (67.6° F.) on the reaction vessel, until all of the anhydrous hydrofluoric acid has volatilized. The vapor phase anhydrous hydrofluoric acid may be passed through a heat exchanger to reduce the temperature below the condensation temperature (19.8° C. or 67.6° F.) at standard atmospheric pressure. The anhydrous hydrofluoric acid recovered in this manner may be condensed and utilized again. Other resultant gaseous products generated during the reaction may be separated from the anhydrous hydrofluoric acid by distillation and condensation, using a separation process that recognizes the difference in boiling and/or condensation points at the operating pressure of this secondary process.

The solid, submicron metal fluoride resultant product may be removed, for example, through the valves and ports provided on the base of the reaction vessel. The resultant solid, submicron metal fluoride product is then placed in an appropriately designed and constructed open container. The container and its contents are then placed in an appropriately designed and constructed oven capable of maintaining an inert environment while heating the metal fluoride. The container and its contents are heated at 95° C.±4° C. for a period of approximately two hours. Thereafter, the temperature of the metal fluoride and its container are brought up to within 10° C. of the metal fluoride's decomposition or melting point, whichever temperature is the lower. The peak temperature is maintained for a period of approximately one hour, then the metal fluoride is cooled to ambient temperature in a sealed desicator, free of all moisture and stray gases.

The metal fluoride may be packaged in a sealed container that will protect the material from coming into contact with moisture, stray gases, or any other substances that might cause the metal fluoride to become contaminated.

In alternative embodiments, the anhydrous metal or metal compound that serves as one of the reactants is less than anhydrous, and/or is less than essentially chemically pure, and/or is not anhydrous and/or chemically pure.

In alternative embodiments, the anhydrous hydrofluoric acid is less than completely anhydrous and/or is not anhydrous.

In some embodiments, the reaction vessel is less than fully clean and/or not cleaned at all.

In alternative embodiments, the reaction vessel is purged and charged with some inert gas other than Nitrogen, or the reaction vessel is less than fully purged with pure nitrogen or other inert gas, and/or the reaction vessel is not purged at all.

In other embodiments, the anhydrous hydrofluoric acid may be introduced into the reaction vessel by any means whatsoever.

In alternative embodiments, the reaction vessel may be set at some temperature other than the predetermined reaction temperature, and/or the reaction vessel is without cooling or heating equipment, or the cooling or heating equipment is not engaged at all.

In other embodiments, the rotation, stirring and/or agitation equipment is only partially engaged or is not engaged at all.

In other embodiments, the anhydrous metal or metal compound is not preheated to the reaction temperature, but is preheated to some other temperature, or is not preheated at all.

In alternative embodiments, the metal or metal compound is categorically introduced into the anhydrous hydrofluoric acid. The method and rate of introduction of the metal or metal compound may be in any percentage aliquot, including 100% of the whole amount and the weight ratio of anhydrous hydrofluoric acid to metal and/or metal compound may be any ratio equal to or greater than the stoichiometric weight combining ratio.

In other embodiments, the internally generated gaseous resultant product is allowed partially to exhaust or is not allowed to exhaust at all.

In other embodiments, the reaction vessel pressure and temperature are not maintained at any specific temperature or pressure, or the reaction vessel pressure and temperature are maintained at some pressure and temperature other than the predetermined reaction pressure and temperature. The reaction vessel, with the reactants within, may be operated with or without rotating, stirring and/or agitation for any period of time, including zero hours.

In alternative embodiments, the anhydrous hydrofluoric acid and the resultant solid, submicron metal fluoride product may be separated by some means other than evaporation of the hydrofluoric acid.

In other embodiments, the resultant solid, submicron metal fluoride product is not dried or is dried at some temperature below the melting point or the decomposition point of the subject metal fluoride, whichever temperature is the lower. Alternatively, the subject metal fluoride may not be cooled in a desicator or protected from environmental contamination.

Although the present invention and its advantages have been described in detail, it should be understood that various changes, substitutions and alterations can be made herein without departing from the invention as defined by the appended claims. Moreover, the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A process for the production of metal fluorides comprising:
introduce a predetermined weight of anhydrous hydrofluoric acid into a reaction vessel and initiate a mixing action;
preheat a predetermined weight of anhydrous metal to a predetermined reaction temperature;
introduce aliquots of the anhydrous metal into the reaction vessel at intervals until the entire predetermined weight of the anhydrous metal has been added;
remove excess anhydrous hydrofluoric acid from the reaction vessel; and
remove a metal fluoride resultant product from the reaction vessel.

2. The process of claim 1 wherein the mixing action is selected from the group consisting of:
rotation,
stirring and
agitation.

3. The process of claim 1 wherein the anhydrous metal is a metal compound.

4. The process of claim 1 wherein the predetermined weight of anhydrous metal is introduced into the reaction vessel through a plunger device and port designed for such purpose.

5. The process of claim 1 further comprising:
exhausting an internally generated gaseous resultant product.

6. The process of claim 5 wherein the internally generated gaseous resultant product is exhausted through an automatic regulating gas back-pressure valve.

7. The process of claim 1 wherein, after the reactants have been fully introduced into the reaction vessel, the reaction vessel is maintained at a predetermined reaction pressure and temperature for a minimum period of time.

8. The process of claim 7 wherein the minimum time is four hours.

9. The process of claim 1 wherein remove the excess anhydrous hydrofluoric acid is removed from the reaction vessel by evaporating the excess acid through a gas backpressure valve.

10. The process of claim 1 further comprising:
place the resultant metal fluoride product in an appropriately designed and constructed open container; and
place the container and its contents in an oven capable of maintaining an inert environment while heating the metal fluoride.

11. The process of claim 10 further comprising:
heating the resultant metal fluoride at 95° C.±4° C. for a period of approximately two hours.

12. The process of claim 11 further comprising:
after heating the metal fluoride at 95° C.±4° C., bring the temperature of the metal fluoride to within 10° C. of the metal fluoride's decomposition or melting point, whichever temperature is lower.

13. The process of claim 12 further comprising:
cooling the metal fluoride to ambient temperature in a sealed desicator that is free of moisture and stray gases.

14. The process of claim 1 wherein the reaction vessel capable of withstanding exposure to anhydrous hydrofluoric acid and capable of operating under internal system working pressures in the range of zero to 400 psia and temperatures in the range of −200° F. to 300° F.

15. The process of claim 14 wherein the reaction vessel is equipped with an automatic regulating gas back pressure valve, settable at back pressures ranging from zero psia to 400 psia.

16. The process of claim 14 wherein the reaction vessel is equipped with a plunger-type device that allows solid, granular reactant materials to be introduced to the reaction vessel, while the reaction vessel is under vacuum or pressure, without allowing fluids to escape from or enter into the reaction vessel.

17. The process of claim 1 further comprising:
purging the reaction vessel a minimum of three successive times with pure nitrogen gas; and
filling the reaction vessel with pure nitrogen gas to the pressure at which it is intended to conduct the reaction.

18. The process of claim 1 wherein the aliquots are 10% of the entire predetermined weight of the anhydrous metal.

19. The process of claim 1 wherein the aliquots are added using a plunger-type device that allows solid, granular reactant materials to be introduced to the reaction vessel, while the reaction vessel is under vacuum or pressure, without allowing fluids to escape from or enter into the reaction vessel.

20. The process of claim 1 wherein the weight ratio of the anhydrous hydrofluoric acid to anhydrous metal is a multiple of the stoichiometric combining weight of the metal reactant.

21. The process of claim 20 wherein the weight ration is not less than 2 and not greater than 60.

22. The process of claim 20 further comprising:
determining an optimum weight ratio comprising:
producing batches of the metal fluoride at various ratios; and
rating the resultant metal fluoride product by its suitability for an intended application of such product.

23. The process of claim 1 wherein the process of removing excess anhydrous hydrofluoric acid from the reaction vessel comprises:
progressively reducing a set pressure on a gas backpressure valve, while maintaining a temperature above 19.8° C. on the reaction vessel, until all of the anhydrous hydrofluoric acid has volatilized.

24. The process of claim 23 further comprising:
passing the volatized vapor phase anhydrous hydrofluoric acid through a heat exchanger to reduce the temperature below the condensation temperature at standard atmospheric pressure; and
recovering and condensing the anhydrous hydrofluoric acid for use in the process again.

25. The process of claim 1 wherein the anhydrous metal is less than anhydrous or not anhydrous.

26. The process of claim 1 wherein the anhydrous metal is less than essentially chemically pure or not chemically pure.

27. The process of claim 1 wherein the anhydrous hydrofluoric acid is less than completely anhydrous or is not anhydrous.

28. The process of claim 1 wherein the reaction vessel is set at a temperature other than the predetermined reaction temperature.

29. The process of claim 1 wherein the mixing action is not engaged.

30. The process of claim 1 wherein the anhydrous metal is preheated to a temperature other than the reaction temperature.

31. A process for the production of metal fluorides comprising:
providing hydrofluoric acid in a reaction vessel;
introducing aliquots of a metal reactant into the reaction vessel at intervals until a predetermined weight of the metal has been added, wherein the weight ratio of the hydrofluoric acid to metal is a multiple of a stoichiometric combining weight of the metal;
agitating the hydrofluoric acid and metal reactants in the reaction vessel;
venting excess hydrogen chloride gas generated during a reaction between the hydrofluoric acid and metal reactants; and
maintaining the hydrofluoric acid and metal reactants at a predetermined pressure and predetermined temperature for a minimum period following the introduction of the metal reactants.

32. The process of claim 31 further comprising:
removing a resultant metal fluoride product from the reaction vessel;
heating the metal fluoride product; and
placing the metal fluoride product in a desicator.

33. The process of claim 31 wherein the hydrofluoric acid and metal reactant are anhydrous.

34. A process for producing ferric trifluoride comprising:
providing hydrofluoric acid in a reaction vessel;
introducing ferric trichloride into the reaction vessel at intervals until a weight ratio of the anhydrous hydrofluoric acid to the ferric trifluoride is between 2 and 60;
agitating the hydrofluoric acid and ferric trichloride in the reaction vessel;
venting excess hydrogen chloride gas generated during a reaction between the hydrofluoric acid and ferric trichloride;
removing excess anhydrous hydrofluoric acid from the reaction vessel; and
removing a ferric trifluoride resultant product from the reaction vessel.
